(19) United States
(12) Patent Application Publication
(10) Pub. No.: US 2007/0178128 A1
(43) Pub. Date: Aug. 2, 2007

(54) EMULSIFIABLE CONCENTRATE (EC) FORMULATIONS FOR PESTICIDES

(75) Inventor: Steven M. BESSETTE, Brentwood, TN (US)

Correspondence Address: NIXON & VANDERHYE, PC, 901 NORTH GLEBE ROAD, 11TH FLOOR, ARLINGTON, VA, 22203, US

(73) Assignee: ECOSMART TECHNOLOGIES, INC., Franklin, TN (US)

(21) Appl. No.: 11/621,070

(22) Filed: Jan. 8, 2007

Related U.S. Application Data
(60) Provisional application No. 60/756,567, filed on Jan. 6, 2006.

(51) Int. Cl. A01N 25/34

(52) U.S. Cl. 424/408

(57) ABSTRACT

Pesticidal emulsifiable concentrate compositions containing at least one EPA exempt plant essential oil compound as a pesticidally active ingredient and a carrier containing an EPA exempt solvent, such as butyl lactate, and methods for using same are disclosed.

### CROSS REFERENCE TO RELATED PATENT APPLICATION

This application claims the benefit of U.S. Provisional Application No. 60/756,567, filed Jan. 6, 2006, the entire disclosure of which is incorporated herein by reference.

### FIELD OF THE INVENTION

The present invention relates to and addresses the need for emulsifiable concentrate (EC) formulations of pesticides (e.g., herbicides, insecticides/miticides, and fungicides) containing EPA exempt active ingredients, as further described below.

### BACKGROUND OF THE INVENTION

Use of pesticides is regulated in the United States by the Environmental Protection Agency (EPA) under authority of the Federal Insecticide, Fungicide and Rodenticide Act (FIFRA). The EPA has issued regulations set forth in 40 Code of Federal Regulations (40 C.F.R.) and those sections pertinent to pesticides are in subchapter E, sections 152 180. To protect the public, pesticides for application to agricultural sites must be registered, unless they contain only ingredients that are “exempt” from the registration procedures of the EPA. These exceptions are updated from time to time and current lists may be obtained from the Environmental Protection Agency website, www.EPA.gov/pesticides. Products containing the exempted active ingredients and permitted inert ingredients are exempt from the registration requirements of FIFRA if contained on the above-mentioned lists.

Exempt pesticides containing plant essential oil compounds as active ingredients have historically been either water-based emulsions or blends of oils requiring addition of a spray tank adjuvant at the time of application which can be time consuming, expensive and/or unreliable in the field. This has been due to the lack of optimal solvents and emulsifiers that meet the exemption criteria.

Conventionally, emulsifiers that have been used in preparing emulsifiable concentrates of pesticidal compositions included Rhodapex™ CQ-436, Rhodapex™ CQ-433, Igepal™ CO-430, Igepal™ CA-630, Igepal™ CQ-887, Isopropanol, canola oil, Alkamuls™ EL-719, Rhodacal™ DS-10, MacoI™ NP-9.5, Tergitol™ TMN-3, Tergitol™ TMN-6, Tergitol™ TMN-10, Morwet™ D425, Tween™ 80 and the light. There are only 2 true emulsifiers on the EPA exemption lists (a.k.a “List 25b” or “List 4A”). The first is lecithin, which usually requires hi-shear mixing to produce an acceptable emulsion. The second is sodium lauryl sulfate (SLS) which also requires the emulsion to be pre-made since it is not soluble in any of the commonly used solvents. However, it has been difficult to obtain suitable emulsifiable pesticidal compositions containing EPA exempt pesticidal active ingredients because such formulations require hi-shear mixing and/or the addition of a tank adjuvant for suitable application.

### BRIEF DESCRIPTION OF THE DRAWINGS

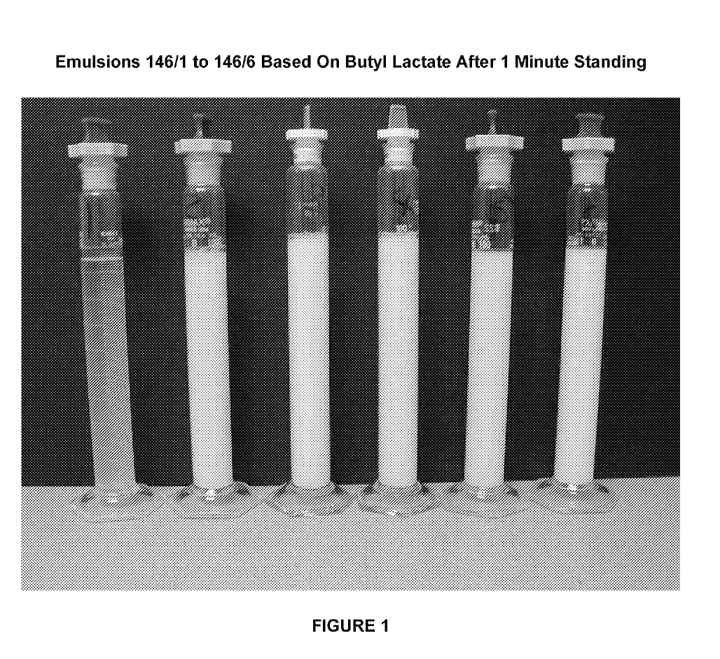

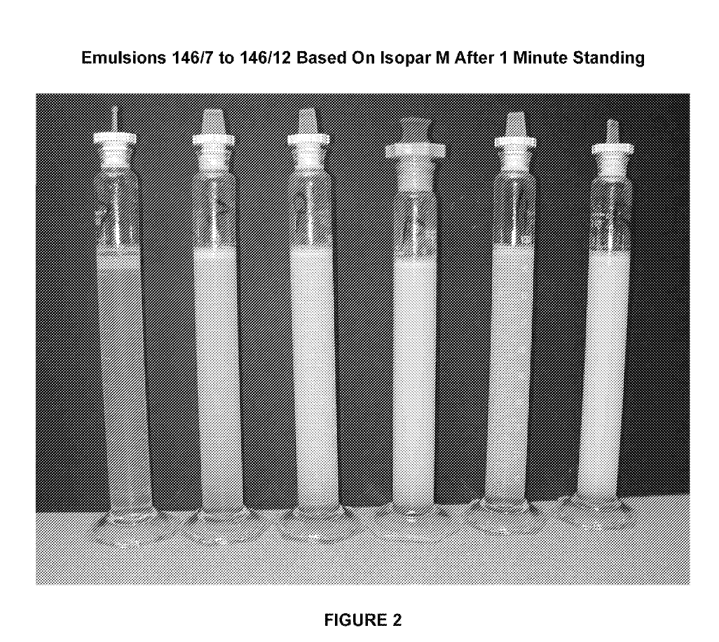

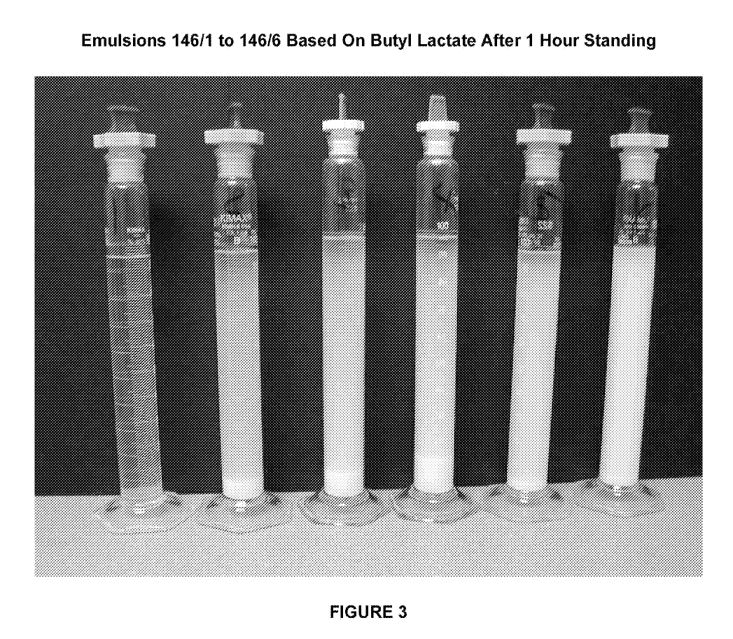

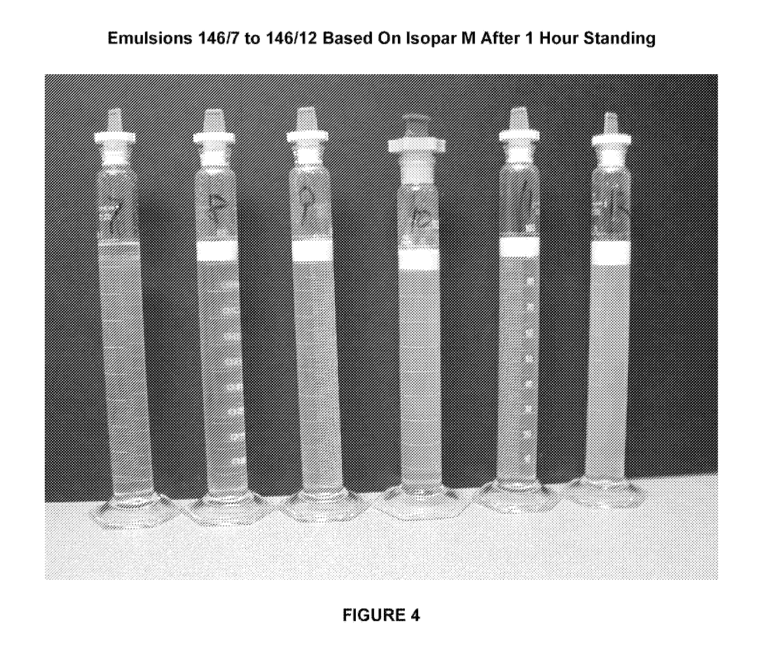

The accompanying FIGS. 1-4, which are incorporated in and constitute a part of the specification, illustrate the present invention and, together with the description, serve to exemplify the principles of the present invention.

### DESCRIPTION OF PREFERRED EMBODIMENTS

All percentages indicated below are by weight of total composition, unless specifically stated otherwise. All percentages and other numeric amounts indicated below are approximate, unless specifically stated otherwise.

Recently the EPA added butyl lactate to the list of exempt solvents. This has led to the breakthrough formulation technology of the present invention which affords the production of highly concentrated and readily self-emulsifiable pesticidal formulations that are exempt from EPA registration. As a result, the butyl lactate formulations of the present invention form spontaneous emulsions in water without the need for hi-shear mixing or the need for a tank adjuvant, although one can still be used if desired. It has been found that butyl lactate is a unique solvent because it has been discovered that it can dissolve both lecithin and SLS at the conventionally or typically used levels in pesticides and is also completely miscible with the active and inert essential oils used in EPA exempted pesticides. This discovery is considered a major breakthrough in the field of EPA exempted pesticides.

The solvents listed in the EPA's exempt lists, especially butyl lactate, can be used in emulsifiable concentrate pesticidal compositions containing at least one pesticidally active ingredient selected from one or more essential oil compounds or derivatives thereof, natural or synthetic, including racemic mixtures, enantiomers, diastereomers, hydrates, salts, solvates and metabolites, etc. Examples of such essential oils that may be included in the pesticidal composition of the present invention include, without limitation, members selected from the group consisting of: α-pinene or β-pinene; α-campholenic aldehyde; α-citronellol; α-iso-amyl-cinnamic (e.g., amyl cinnamic aldehyde); α-pinene oxide; α-cinnamic terpinene; α-terpineol (e.g., methods. 1-methyl-4-isopropyl-1-cyclohexen-8-ol); λ-terpinene; achillea; aldehyde C16 (pure); alpha-phellandrene; amyl cinnamic aldehyde; amyl salicylate; anethole; anise; aniseed; anisic aldehyde; basil; bay; benzyl acetate; benzyl alcohol; bergamot (e.g., Monardia fistulosa, Monarda didyma, Citrus bergamia, Monarda punctata); bitter orange peel; black pepper; borneol; calamus; camphor; cananga oil (e.g., java); cardamom; carnation (e.g., dianthus caryophyllus); carvacrol; carveol; cassia; castor; cedar (e.g., hinoki); cedarwood; chamomile; cineole; cinnamaldehyde; cinnamic alcohol; cinnamon (e.g., cinnamon leaf oil); cis-pinane; citral (e.g., 3,7-dimethyl-2,6-octadienal); citronella; citronellal; citronellol dextro (e.g., 3-7-dimethyl-6-octen-1-ol); citronellol; citronellyl acetate; citronellyl nitrile; citrus unshiu; clary sage; clove (e.g., eugenia caryophyllus); clove bud; coriander; corn; cotton seed; d-dihydrocarvone; decyl aldehyde; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin (e.g., 3-ethoxy-4-hydrobenzaldehyde); eucalyptol (e.g., cineole); eucalyptus citriodora; eucalyptus globulus; eucalyptus; eugenol (e.g., 2-methoxy-4-allyl phenol); evening primrose; fenchol; fennel; ferniol™; fish; florazon (e.g., 4-ethyl-α,α-dimethyl-benzenepropanal); galaxolide; geraniol (e.g., 2-trans-3,7-dimethyl-2,6-octadien-8-ol); geraniol; geranium; geranyl acetate; geranyl nitrile; ginger; grapefruit; guaiacol; guaiacwood; gurjun balsam; heliotropin; herbanate (e.g., 3-(1-methyl-ethyl)bicyclo(2,2,1)hept-5-ene-2-carboxylic acid ethyl ester); hiba; hydroxycitronellal; i-carvone; i-methyl acetate; ionone; isobutyl quinoleine (e.g., 6-secondary butyl quinoline); isobornyl acetate; isobornyl methylether; isoeugenol; isolongifolene; jasmine; jojoba; juniper berry; lavender; lavandin; lemon grass; lemon; lime; limonene; linallol oxide; linallol; linalool; linalyl acetate; linseed; litsea cubeba; l-methyl acetate; longifolene; mandarin; mentha; menthane hydroperoxide; menthol crystals; menthol laevo (e.g., 5-methyl-2-isopropyl cyclohexanol); menthol; menthone laevo (e.g., 4-isopropyl-1-methyl cyclohexan-3-one); methyl anthranilate; methyl cedryl ketone; methyl chavicol; methyl hexyl ether; methyl ionone; mineral; mint; musk ambrette; musk ketone; musk xylol; mustard (also known as allylisothio-cyanate); myrcene; nerol; neryl acetate; nonyl aldehyde; nutmeg (e.g., myristica fragrans); orange (e.g., citrus aurantium dulcis); orris (e.g., iris florentina) root; para-cymene; para-hydroxy phenyl butanone crystals (e.g., 4-(4-hydroxyphenyl)-2-butanone); passion palmarosa oil (e.g., cymbopogon martini); patchouli (e.g., pogostemon cablin); p-cymene; pennyroyal oil; pepper; peppermint (e.g., mentha piperita); perillaldehyde; petitgrain (e.g., citrus aurantium amara); phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; (take this out?rose; rosemary (e.g., rosmarinus officinalis) ryu; sage; sandalwood (e.g., santalum album); sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin (e.g., 4-hydroxy-3-methoxy benzaldehyde); vetiver; vitalizair; white cedar; white grapefruit; (wintergreen) and the like. As these plant essential oil compounds are known and used for other uses, they may be prepared by a skilled artisan by employing known methods. For example, the synthetic form of wintergreen oil (methyl salicylate) may also be used in the embodiment.

It will be appreciated by the skilled artisan that the pesticidal compositions of the present invention unexpectedly exhibit excellent pesticidal activities using two or more U.S. Food and Drug Administration approved plant essential oils, in lieu of conventional pesticides which are not safe for use in households and other sensitive areas, or in lieu of pesticidal compositions containing individual plant essential oils. It will also be appreciated by the skilled artisan that the pesticidal compositions of the present invention provide affordable pesticidal formulations that are aesthetically acceptable. It will also be appreciated by the skilled artisan that the pesticidal compositions of the present invention unexpectedly exhibit excellent pesticidal activities, specifically knockdown and mortality, using water-based emulsions in both pressurized (e.g. an aerosol) and non-pressurized systems in lieu of conventional oil based solvent systems.

The present invention encompasses EC mixtures in which at least one exempt plant essential oil, as active ingredient, is present in an amount substantially between about 0.01 to about 100% by weight, and preferably about 0.5 to about 90% by weight, of the mixture, and all subranges therebetween, whereas carrier composition mixtures suitable for direct application or field application generally contemplate those in which the active compound is present in an amount substantially between about 0.0001 to about 10%, preferably about 0.01 to about 2%, by weight of the mixture and all subranges therebetween. Thus, the present invention contemplates over-all formulations with butyl lactate present in an amount that is generally between about 0.0001 to about 99%, and preferably about 0.01 to about 95%, by weight of the mixture and all subranges therebetween.

Suitable butyl lactate containing EC pesticidal formulations of the present invention include, without limitation, the following:

Sample Formulation 1
Butyl Lactate
Cinnamon
Clove
Isopropyl Alcohol
Isopropyl Myristate
Lemongrass
Peppermint
Thyme
Vanillin

Sample Formulation 2
Butyl Lactate (solvent)
Cinnamon
Clove
Isopropyl Myristate
Lemongrass
Peppermint
Thyme
Vanillin

Sample Formulation 3
Butyl Lactate (solvent)
Peppermint
Propellant
Rosemary
Vanillin
Wintergreen

Sample Formulation 4
Butyl Lactate (solvent)
Cinnamon
Eugenol
Lecithin
Lemongrass
Rosemary
Thyme
Wintergreen

Sample Formulation 5
Butyl Lactate (solvent)
Eugenol
Isopropyl Myristate
Lecithin
Mineral Oil
Phenyl Ethyl Propionate
Sodium Lauryl Sulfate
Wintergreen

Sample Formulation 6
Butyl Lactate (solvent)
Clove
Lecithin
Wintergreen

Sample Formulation 7
Butyl Lactate (solvent)
Clove
Lecithin
Rosemary
Thyme
Wintergreen

Sample Formulation 8
Butyl Lactate (solvent)
Eugenol
Lecithin
Rosemary
Sodium Lauryl Sulfate
Thyme
Wintergreen

Sample Formulation 9
Butyl Lactate (solvent)
Lecithin
Peppermint
Rosemary
Sodium Lauryl Sulfate
Vanillin
Wintergreen

Sample Formulation 10
Butyl Lactate (solvent)
Lecithin
Mineral Oil
Peppermint
Rosemary
Sodium Lauryl Sulfate
Vanillin
Wintergreen

Sample Formulation 11
Butyl Lactate (solvent)
Cinnamon
Lecithin
Lemongrass
Mineral Oil
Peppermint
Phenyl Ethyl Propionate
Sodium Lauryl Sulfate
Thyme
Vanillin
Wintergreen

Sample Formulation 12
Butyl Lactate (solvent)
Cinnamon
Geraniol
Lemongrass
Peppermint
Phenyl Ethyl Propionate
Propellant
Sesame
Vanillin
Wintergreen

Sample Formulation 13
Butyl Lactate (solvent)
Cinnamon
Geraniol
Lecithin
Lemongrass
Mineral Oil
Pepperimint
Rosemary
Sodium Lauryl Sulfate
Thyme
Vanillin
Wintergreen

Sample Formulation 14
Butyl Lactate (solvent)
Eugenol
Glacial Acetic Acid
Hydroxypropylcellulose
Lecithin
Phenyl Ethyl Propionate
Sodium Lauryl Sulfate

Sample Formulation 15
Butyl Lactate (solvent)
Cinnamon
Eugenol
Lecithin
Lemongrass
Rosemary
Thyme
Wintergreen

Sample Formulation 16
Butyl Lactate (solvent)
Cinnamon
Geraniol
Lecithin
Lemongrass
Peppermint
Rosemary
Sodium Lauryl Sulfate
Vanillin
Wintergreen

Sample Formulation 17
Butyl Lactate (solvent)
Lecithin
Mineral Oil
Rosemary
Sodium Lauryl Sulfate
Wintergreen

Sample Formulation 18
Butyl Lactate (solvent)
Eugenol
Glacial Acetic Acid
Lecithin
Sodium Lauryl Sulfate
Wintergreen

Sample Formulation 19
Butyl Lactate (solvent)
Clove
Glacial Acetic Acid
Lecithin
Wintergreen

Sample Formulation 20
Butyl Lactate (solvent)
Geraniol
Peppermint
Phenyl Ethyl Propionate
Propellant
Sesame
Vanillin
Wintergreen

Sample Formulation 21
Butyl Lactate (solvent)
Peppermint
Propellant
Rosemary
Vanillin
Wintergreen

The pesticidal compositions of the present invention may offer one or more of the following non-limiting advantages over currently used pesticides. First, the preferred essential oils used in the composition of the invention are naturally occurring compounds, and as such are relatively nontoxic to humans, domestic animals and wildlife. Consequently, when used for treating plant pests, food crops can be treated using the composition up to and immediately before the harvesting period, a practice that generally is avoided when using conventional methods of pest control. The EC compositions of the present invention also can be used to control the growth of pest organisms on harvested crops. The harvested food can be used directly as food for animals or humans with little fear of (residual toxicity) or phytotoxicity. By using the subject compositions, the environmental and health hazards involved in pest control are minimized. Because of the versatility and broad spectrum of the present composition, when necessary, the composition can be used as a preventative on a repeated basis and, thus, can be integrated into integrated pest management (IPM) programs. The composition can be applied to skin or to objects such as clothing, fur, feathers, or hair that come into contact with skin when used to treat pests that infest animals. The essential oils, i.e., the active ingredients, of the pesticidal compositions of the present invention are believed to be biorational chemicals that may qualify for the US EPA Biopesticide Program.

In some aspects, the EC pesticidal compositions of the present invention have not previously been used against microorganisms, and therefore, fungal and bacterial pathogens and other pest organisms have not acquired resistance to them. Disease resistance to chemicals other than the heavy metals occurs commonly in pests such as fungi and on rare occasions in bacterial plant disease pests. A new pesticide often becomes noticeably less effective against a particular disease after several growing seasons. As pesticides become more specific for diseases, the pests become resistant. Without wishing to be bound by any theory, this can be attributed to the singular mode of action of a particular pesticide, which disrupts only one genetically controlled process in the metabolism of the pest organism. The result is that resistant populations appear suddenly, either by selection of resistant individuals in a population or by a single gene mutation. Generally, the more specific the site and mode of a pesticidal action, the greater the likelihood for a pest organism to develop a tolerance to that chemical. A new composition will solve the disease resistance problem. To avoid developing future disease resistance in pests, different chemicals should be alternated for treatment with the methods of the invention.

Methods of using the pesticidal compositions of the present invention offer several advantages over existing methods of pest control. The formulations of the subject invention provide for effective control of insects, mites, fungi and microorganisms In particular situations, such as where an insect damages a plant part or tissue and a secondary fungal disease develops, this aspect of the invention is particularly advantageous. The pesticidal compositions according to the invention have very good fungicidal properties and can be employed for controlling phytopathogenic fungi, such as, without limitation, plasmodiophoromycetes, oomycetes, chytridiomycetes, zygomycetes, ascomycetes, basidiomycetes, deuteromycetes, etc. Fungal phytopathogens particularly associated with crop plants and included within the scope of the present invention include, without limitation, the following: Miscellaneous Fungal Diseases (e.g., Septoria tritici, Septoria nodorum); Gibberella ear mold (e.g., e.g., Gibberella zeae, G. saubinetti); Aspergillus ear rot (e.g., Aspergillus flavus, A. parasiticus); Diplodia ear rot (e.g., Diplodia maydis, D. macrospora); Fusarium ear rot (e.g., Fusarium moniliforme, F. monilif. var. subglutinans); Pythium stalk rot (e.g., Pythium aphanidermata); Anthracnose stalk rot (e.g., Colletotrichum graminicola, C. tucumanensis, Glomerella graminicola); Diplodia stalk rot (e.g., Diplodia maydis, D. zeae-maydis, Stenocarpella maydis, Macrodiplodia zeae, Sphaeria maydis, S. zeae, D. macrospora); Fusarium stalk rot (e.g., Fusarium moniliforme); Gibberella stalk rot (e.g., G. zeae, G. saubinetti); Stewart's wilt & leaf blight (e.g., Erwinia stewartii); Northern corn leaf blight (e.g., Exserohilum turcicum); Southern corn leaf blight (e.g., Bipolaris maydis); Gray leaf spot (e.g., Cercospora zeae-maydis, C. sorghi var. maydis); Anthracnose leaf blight (e.g., Colletotrichum graminicola); Common rust (e.g., Puccinia sorghi, P. maydis); Southern rust (e.g., Puccinia polysora, Dicaeoma polysorum); Head smut (e.g., Sphacelotheca reiliana); Common smut (e.g., Ustilago maydis); Carbonum leaf spot (e.g., Helminthosporium carbonum); Eye spot (e.g., Kabatiella zeae); Sorghum downy mildew (e.g., Peronosclerospora sorghi); Brown stripe downy mildew (e.g., Sclerophthora rayssiae); Sugarcane downy mildew (e.g., Peronosclerospora sacchari); Phillipine downy mildew (e.g., Peronoscler. Philippinensis); Java downy mildew (e.g., Peronosclerospora maydis); Spontaneum downy mildew (e.g., Peronosclerospora spantanea); Rajasthan downy mildew (e.g., Peronosclerospora heteropogoni); Graminicola downy mildew (e.g., Sclerospora graminicola); Rusts (e.g., Puccinia graminis f.sp. tritici, Puccinia recondita f.sp. tritici, Puccinia striiformis); Smuts (e.g., Tilletia tritici, Tilletia controversa, Tilletia indica, Ustilago tritici, Urocystis tritici); Root rots, Foot rots and Blights (e.g., Gaeumannomyces graminis, Pythium spp., Fusarium culmorum, Fusarium graminaerum, Fusarium avenaceum, Drechslere tritici-repentis, Rhizoctonia spp., Colletotrichum graminicola, Helminthosporium spp., Microdochium nivale, Pseudocercosporella herpotrichoides); Mildews (e.g., Erysiphe graminis f.sp. tritici, Sclerophthora macrospora), and the like.

The long term control of pests results in plants with an improved quality and yields of produce by host plants as compared with untreated plants. The low concentration and single dose of anti-pest agents decreases the likelihood of damage to the plant and/or its crop, and decreases the likelihood of adverse side effects to workers applying the pesticide, or to animals, fish or fowl which ingest the tissues or parts of treated plants. The methods of use of the pesticidal compositions of the invention will depend at least in part upon the pest to be treated and its feeding habits, as well as breeding and nesting habits. While very minor dosage rates of the novel compositions will have an adverse effect on pests, adequate control usually involves the application of a sufficient amount to either eliminate pests entirely or significantly deter their growth and/or rate of proliferation. Dosage rates required to accomplish these effects, of course, vary depending on the target pest, size, and maturity, i.e., stage of growth. More mature pests may be more resistant to pesticides and require higher dosage rates for a comparable level of control. Dose response experiments using different dilutions (for example, about 1:1000, 1:100, 1:10 and 1:3) of the pesticidal compositions of the present invention on target organisms and on plants are performed to determine the optimal concentration of the active essential oil compound(s) that show(s) pesticidal activity without phytotoxicity or dermal sensitivity. For instance, when the pesticidal composition of the present invention is utilized for agricultural purposes, an amount from about 0.1 to 2,000 g/ha of the active ingredients (and all subranges therebetween) is employed onto the soil, plants, or directly onto the harmful pests, preferably as an emulsifiable concentrate or emulsion usually at a rate from 1 to 2000 ppm and all subranges therebetween.

In another preferred embodiment, a pesticidal composition of the present invention useful for treating (e.g., preventing, controlling, impeding, and the like) infectious or pathogenic bacterial, viral, microbial, and other diseases causing pests is provided which includes applying an effective amount of the pesticidal composition to a locus in need thereof for controlling, treating, managing, preventing, or the like, the spread of diseases caused by germs, bacteria, or viruses such as Escherichia coli, salmonella, staphylococci, streptococci, influenza, pneumonia, various blood and urine bacterial pathogens, and the like. The present invention further encompasses treatment of the following: gram-positive cocci that cause staphylococcal infections such as pneumonia, bacteremia, osteomyelitis, enterocolitis, and the like; streptococci that cause infections such as hemolytic, viridans, enterococci, lactic, and the like; pneumococci that cause infections such as pneumonia, sinusitis, otitis, Meningitis, and the like; gram-negative cocci such as meningococcus, gonococcus, and the like; gram-positive bacilli that cause infections such as erysipelothricosis, listeriosis, anthrax, nocardiosis, and the like; gram-negative bacilli that cause infections such as enterobacteriaceac salmonella, shigellosis, hemophilus, tularemia, plaque, melioidosis, bartonellosis, campylobacter, and noncholera vibrio, and the like; anaerobic bacilli that cause infections such as clostridium botulinum, clostridium tetany, clostridia of gas gangrene bacteroides, mixed anaerobic, actinomycosis, and the like; mycobacteria that cause infections such as tuberculosis and leprosy, and the like; and spirochetes that cause diseases such as leptospirosis, lyme disease, and endemic treponematoses. Further, the present invention, the pesticidal compositions may be useful for treating surfaces containing infectious human immunodeficiency virus (HIV), influenza, A, B, and C, parainfluenza viruses 1-4, rhonoviruses (common cold), mumps virus, adenoviruses, reoviruses, and epstein-Barr virus, infants and adult syncytial virus, primary atypical pneumonia, polioviruses, coxsackieviruses, echoviruses and high numbered viruses, epidemic gastroenteritis viruses, rubeola virus, rubella virus, varicella-zoster virus, herpes simplex, human herpes virus type 6, human parvovirus B19, cytomegalovirus, hepatitis viruses types A, B, C, D, human Papillomavirus, molluscum contagiosum virus, arboviruses, togaviruses, alphaviruses, flaviviruses, bunyaviruses, orbivirus, rabies virus, herpesvirus simiae, arenaviruses, filoviruses, and the like.

By way of example, and not intending to be limited hereby, the present invention will be further exemplified below. The following Example are illustrative of various embodiments only and do not limit the claimed invention regarding the materials, conditions, weight ratios, process parameters and the like recited herein.

### EXAMPLE

Tests were conducted on emulsifiable concentrate formulations to determine (1) emulsion bloom (spontaneity) when poured into water-containing cylinders (see figures), (2) emulsion suspensibility (resistance to separation) after 1 hour standing; and (3) emulsion droplet size (as measured by laser sizer manufactured by Malvern Instruments Ltd.). The formulations were prepared using either butyl lactate or Isopar M (an aliphatic hydrocarbon), which is typically used in pesticides, as a solvent. The tested formulations had different amounts of lecithin emulsifier from about 0% to about 3% and some formulations also had sodium lauryl sulfate (“SLS”) as an additional emulsifier at about 0.5%. Formulation compositions and results of physical tests are provide in Tables 1 and 2 below and further shown in FIGS. 1 to 4.

TABLE I
Formulations Using Butyl Lactate As Solvent

| Ingredient/ | | | | | | |
|---|---|---|---|---|---|---|
| Formulation No. | 146/1 | 146/2 | 146/3 | 146/4 | 146/5 | 146/6 |
| Rosemary oil | 10.0 | 10.0 | 10.0 | 10.0 | 10.0 | 10.0 |
| Wintergreen oil | 43.0 | 43.0 | 43.0 | 43.0 | 43.0 | 43.0 |
| Peppermint oil | 2.0 | 2.0 | 2.0 | 2.0 | 2.0 | 2.0 |
| Vanillin | 3.0 | 3.0 | 3.0 | 3.0 | 3.0 | 3.0 |
| Lecithin | — | 1.0 | 2.0 | 3.0 | 1.0 | 3.0 |
| SLS | — | — | — | — | 0.5 | 0.5 |
| Butyl lactate | 42.0 | 41.0 | 40.0 | 39.0 | 40.5 | 38.5 |

PHYSICAL TEST RESULTS

| | | | | | | |
|---|---|---|---|---|---|---|
| Bloom Rating¹ | 0 | 3.5 | 4.0 | 4.5 | 4.9 | 5.0 |
| Suspensibility | 3 ml of | 8 ml of | 10 ml of | 15 ml of | 4 ml of | 5 ml of |
| (ml of separation | bottom | bottom | bottom | bottom | bottom | bottom |
| after 1 hour) | consisted | consisted | consisted | consisted | consisted | consisted |
| | of oil | of cream | of cream | of cream | of cream | of cream |

PARTICLE SIZE (MICRONS)

| | | | | | | |
|---|---|---|---|---|---|---|
| 10% < | 31 | 18 | 17 | 19 | 7 | 5 |
| 50% < | 50 | 34 | 32 | 36 | 18 | 18 |
| 80% < | 69 | 50 | 48 | 53 | 27 | 32 |
| 90% < | 81 | 60 | 57 | 63 | 34 | 41 |
| 99% < | 117 | 85 | 81 | 89 | 51 | 64 |

| | | |
|---|---|---|
| ¹Code | Rating | Observations |
| 5 | Excellent | White billowing emulsion, no droplets observed |
| 4 | Good | White billowing emulsion, very few droplets break away |
| 3 | Fair | White emulsion, some droplets break away |
| 2 | Poor | Poor emulsion, many oil droplets observed |
| 1-0 | Unacceptable | No emulsion, all oil droplets observed |

TABLE 2
Formulations Using Isopar M As Solvent

| Ingredient/ | | | | | | |
|---|---|---|---|---|---|---|
| Formulation No. | 146/1 | 146/2 | 146/3 | 146/4 | 146/5 | 146/6 |
| Rosemary oil | 10.0 | 10.0 | 10.0 | 10.0 | 10.0 | 10.0 |
| Wintergreen oil | 43.0 | 43.0 | 43.0 | 43.0 | 43.0 | 43.0 |
| Peppermint oil | 2.0 | 2.0 | 2.0 | 2.0 | 2.0 | 2.0 |
| Vanillin | 3.0 | 3.0 | 3.0 | 3.0 | 3.0 | 3.0 |
| Lecithin | — | 1.0 | 2.0 | 3.0 | 1.0 | 3.0 |
| SLS | — | — | — | — | 0.5 | 0.5 |
| Isopar M | 42.0 | 41.0 | 40.0 | 39.0 | 40.5 | 38.5 |

PHYSICAL TEST RESULTS

| | | | | | | |
|---|---|---|---|---|---|---|
| Bloom (see rating | 0 | 0.1 | 0.2 | 0.3 | 0.1 | 0.3 |
| scale above) | | | | | | |
| Suspensibility | 5 ml of top | 9 ml of top | 10 ml of | 11 ml of | 9 ml of top | 13 ml of |
| (ml of separation | consisted | cream | top cream | top cream | cream | top cream |
| after 1 hour) | of oil | | | | | |

PARTICLE SIZE (MICRONS)

| | | | | | | |
|---|---|---|---|---|---|---|
| 10% < | 38 | 24 | 26 | 28 | 24 | 26 |
| 50% < | 63 | 38 | 42 | 46 | 38 | 41 |
| 80% < | 87 | 50 | 57 | 65 | 52 | 56 |
| 90% < | 103 | 57 | 67 | 77 | 61 | 64 |
| 99% < | 145 | 76 | 96 | 115 | 86 | 87 |

The above data demonstrates that SLS does not dissolve in the Isopar M based formulations but remains as suspended white particles and that formulations without emulsifiers did not emulsify. Further, observed emulsion bloom (spontaneity) was “good” in all samples containing butyl lactate and lecithin and “excellent” in those samples containing butyl lactate, lecithin and SLS. Complete emulsification was achieved without the need for agitation of the cylinders. In contrast, there was no observed emulsion bloom in any of the formulations containing Isopar M. Further, the Isopar M based formulations required vigorous shaking to form an emulsion which broke rapidly. As such, emulsifiable concentrates containing butyl lactate and lecithin and/or SLS readily emulsify when poured into water and therefore can be easily used for agricultural and other applications. Emulsifiable concentrates containing Isopar M and lecithin and SLS do not self emulsify and are unsuitable for use in agricultural applications. Emulsifiable concentrate samples based on butyl lactate with both lecithin and SLS performed better than those with butyl lactate and only lecithin. Hence, the present invention affords the ability to dissolve SLS in an exempt solvent that is compatible with exempt plant essential oils, thereby providing pesticidal emulsions that are both spontaneous and stable.

As can be seen from the above discussion, the pesticidal emulsifiable concentrates containing EPA-exempt active compounds according to the present invention are markedly superior to known pesticidal agents/active compounds conventionally used as pesticides (e.g., herbicides, insecticides/miticides, and fungicides).

Although illustrative embodiments of the invention have been described in detail, it is to be understood that the present invention is not limited to those precise embodiments, and that various changes and modifications can be effected therein by one skilled in the art without departing from the scope and spirit of the invention as defined herein.

What is claimed is:

1. A pesticidal composition comprising butyl lactate and a pesticidally-effective active ingredient selected from the group consisting of: α-pinene; β-pinene; α-campholenic aldehyde; α-citronellol; α-iso-amyl-cinnamic; amyl cinnamic aldehyde; α-pinene oxide; α-cinnamic terpinene; α-terpineol; 1-methyl-4-isopropyl-1-cyclohexen-8-ol; λ-terpinene; achillea; aldehyde C16 (pure); alpha-phellandrene; amyl cinnamic aldehyde (amylcinnamaldehyde); amyl salicylate; anethole; anise; aniseed; anisic aldehyde; basil; bay; benzyl acetate; benzyl alcohol; bergamot; bitter orange peel; black pepper; borneol; bornyl acetate; calamus; camphor; camphor wood oil; cananga oil; cardamom; carnation; caryophyllene; carvacrol; carveol; carvone; cassia; castor; cedar; cedarwood; chamomile; cineole; cinnamaldehyde; cinnamic alcohol; cinnamon; cis-pinane; citral; citronella; citronellal; citronellol dextro; citronellol; citronellyl acetate; citronellyl nitrile; citrus unshiu; clary sage; clove oil; clove bud; coriander; corn; cotton seed; coumarin; d-dihydrocarvone; decyl aldehyde; diethyl phthalate; dihydroanethole; dihydrocarveol; dihydrolinalool; dihydromyrcene; dihydromyrcenol; dihydromyrcenyl acetate; dihydroterpineol; dimethyl salicylate; dimethyloctanal; dimethyloctanol; dimethyloctanyl acetate; diphenyl oxide; dipropylene glycol; d-limonene; d-pulegone; estragole; ethyl vanillin; eucalyptol; eucalyptus citriodora; eucalyptus globulus; eucalyptus; eugenol; eugenyl acetate; evening primrose; fenchol; fennel; ferniol™; fish; florazon; galaxolide; geraniol; geraniol; geranium; geranyl acetate; geranyl nitrile; ginger; grapefruit; guaiacol; guaiacwood; gurjun balsam; heliotropin; herbanate; hexylcinnamaldehyde; hiba; hydroxycitronellal; i-carvone; i-methyl acetate; ionone; isobutyl quinoleine; isobornyl acetate; isobornyl methylether; isoeugenol; isolongifolene; isosafrole; jasmine; jojoba; juniper berry; lavender; lavandin; lemon grass; lemon; lime; limonene; linallol oxide; linallol; linalool; linalyl acetate; linseed; litsea cubeba; l-methyl acetate; longifolene; mandarin; mentha; menthane hydroperoxide; menthol; menthyl acetate; menthofurane; menthol laevo; methyl anthranilate; methyl cedryl ketone; methyl chavicol; methyl hexyl ether; methyl ionone; mineral; mint; musk ambrette; musk ketone; musk xylol; mustard; myrcene; neral; nerol; neryl acetate; nonyl aldehyde; nutmeg; orange; orris root; para-cymene; para-hydroxy phenyl butanone crystals; passion palmarosa oil; patchouli; p-cymene; pennyroyal oil; pepper; peppermint; perillaldehyde; petitgrain; phenyl ethyl alcohol; phenyl ethyl propionate; phenyl ethyl-2-methylbutyrate; pimento berry; pimento leaf; pinane hydroperoxide; pinanol; pine ester; pine needle; pine; pinene; piperonal; piperonyl acetate; piperonyl alcohol; plinol; plinyl acetate; pseudo ionone; rhodinol; rhodinyl acetate; rosalin; rose; rosemary; ryu; safrole; sage; sandalwood; sandenol; sassafras; sesame; soybean; spearmint; spice; spike lavender; spirantol; starflower; tangerine; tea seed; tea tree; terpenoid; terpineol; terpinolene; terpinyl acetate; tert-butylcyclohexyl acetate; tetrahydrolinalool; tetrahydrolinalyl acetate; tetrahydromyrcenol; thulasi; thyme; thymol; tomato; trans-2-hexenol; trans-anethole and metabolites thereof; turmeric; turpentine; vanillin; verbenone; vetiver; vitalizair; white cedar; white grapefruit; and wintergreen (methyl salicylate).

2. The pesticidal composition as defined in claim 1, further comprising sodium lauryl sulfate.

3. The pesticidal composition as defined in claim 1, further comprising lecithin.

4. The pesticidal composition as defined in claim 1, further comprising sodium lauryl sulfate and lecithin.

5. A method for killing or controlling pests, which comprises applying to the pests or a locus where killing or control of pests is desired a pesticidally-effective amount of the pesticidal composition of claim 1.
